(19) United States
(12) Patent Application Publication
(10) Pub. No.: US 2016/0352577 A1
(43) Pub. Date: Dec. 1, 2016

(54) MULTIPLE GATEWAY VIRTUALIZATION

(71) Applicant: NIMBUS 9, INC., Colorado Springs, CO (US)

(72) Inventors: Lucas SCHIFF, Monument, CO (US); Andrew HUTCHISON, Colorado Springs, CO (US)

(21) Appl. No.: 14/828,290

(22) Filed: Aug. 17, 2015

Related U.S. Application Data
(60) Provisional application No. 62/166,797, filed on May 27, 2015.

(51) Int. Cl. H04L 12/24; H04L 29/08; H04L 29/06

(52) U.S. Cl. CPC H04L 41/0893; H04L 65/102; H04L 41/0806; H04L 67/025

(57) ABSTRACT

Systems, software, and methods are provided for controlling many remote gateways that reside at a single site or location and mesh all devices attached to the gateways into one virtualized list of devices for the purpose of controlling, monitoring or using a triggers for control or monitoring without the need to know which gateway a particular device is associated with, or other detailed device or gateway specific information.

### CROSS REFERENCE TO RELATED APPLICATIONS

This patent application is related to, and claims priority to, U.S. Provisional Patent Application No. 62/166,797, entitled “Multiple Gateway Virtualization,” filed on May 27, 2015, which is hereby incorporated by reference for all purposes.

### BACKGROUND

Many systems allow for some control of devices using remote devices, the Internet, and the cloud. These systems are cumbersome and the user may need to know and use a lot of device specific information to control the devices.

### OVERVIEW

Systems, software, and methods are provided for controlling many remote gateways that reside at a single site or location, and mesh all devices attached to the gateways into one virtualized list of devices for the purpose of controlling, monitoring or using triggers for control or monitoring without the need to know which gateway a particular device is associated with, or other detailed device specific information.

### BRIEF DESCRIPTION OF THE DRAWINGS

FIG. 1 is a system diagram illustrating multiple gateway virtualization system, according to an example.

FIG. 2 is a flow diagram of a method according to an example.

FIG. 3 illustrates a database configuration and function, according to an example.

FIG. 4 illustrates a monitoring computing environment according to one example.

### DESCRIPTION

What may be needed in the controls industry is a complete end to end solution that is centered on the cloud accomplishing the central intelligence of the control system. One of the hurdles that must be overcome is not the ability to connect devices to the Internet, but to provide the ability to connect devices as one contiguous system so that a user doesn't have to know large amounts of device specific information, such as where the device is located, to which gateway it is connected, and specific device configuration and communication information, but is presented with a master list of all devices available. This may be implemented via a multi-gateway virtualization of the control system.

The purpose of an example system is to create a contiguous user experience when operating multiple gateways within a single site or location that connect sensors and devices, such as: photocell sensors, occupancy sensors, lighting devices, HVAC devices, security devices, security sensors, home appliances, electrical devices, smart meters, irrigation devices, power monitors, and other devices, etc. This is meant to include anything that might be part of automating a building or home, and the Internet of things, but does not exclude other applications such as: industrial, agriculture, transportation and logistics, energy and utilities, healthcare, government and public services.

In principle, an example cloud service allows a user to take many remote gateways that reside at a single site or location and mesh all devices attached to the gateways into one virtualized list of devices for the purpose of controlling, monitoring or using a trigger for control or monitoring without the need to know which gateway a particular device is associated with, and/or other device specific information.

Systems, software, and methods are provided for controlling many remote gateways that reside at a single site or location and mesh all devices attached to the gateways into one virtualized list of devices for the purpose of controlling, monitoring or using a trigger for control or monitoring without the need to know which gateway a particular device is associated with, or other detailed device specific information.

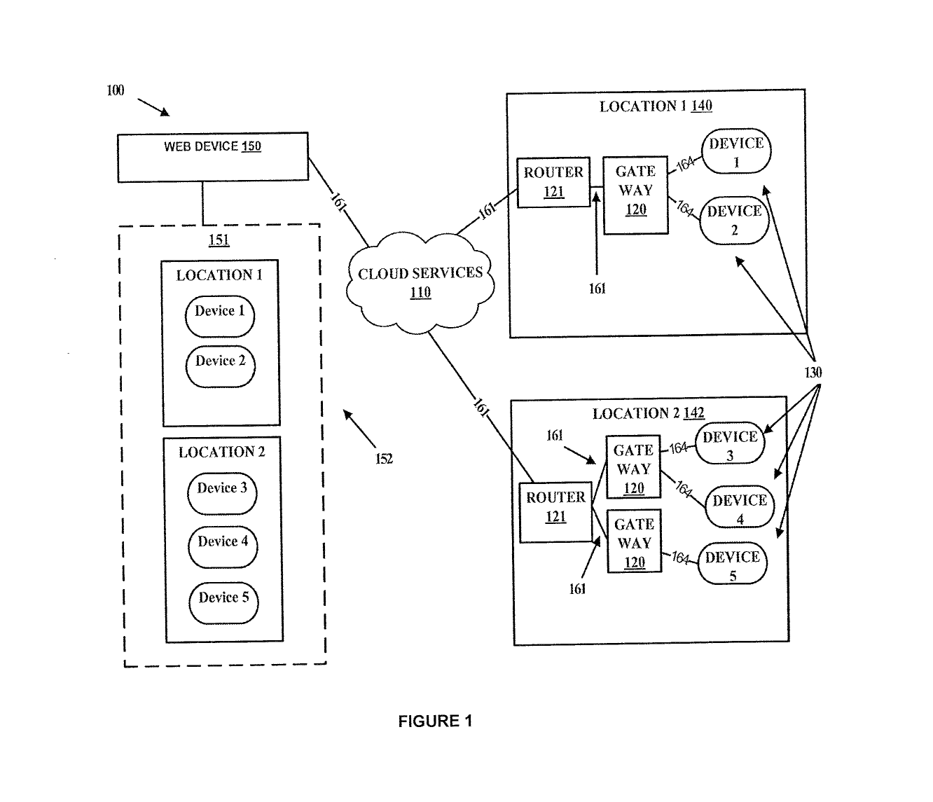

FIG. 1 is a system diagram illustrating multiple gateway virtualization system 100, according to an example. System 100 includes cloud services 110, one or more gateways 120, one or more routers 121, devices 130, locations 140 142, web device 150, and displayed information/user interface 151. Web device 150 communicates over link 161 to cloud services 110. Router 121 may include an Internet router, which, communicates over link 161 to cloud services 110. Gateways 120 communicate over link 161 to routers 121. Devices 130 communicate over link 164 to gateways 120.

Cloud services 110 is shown as a generic cloud, with multiple underlying services and technologies which comprise a service to an end user. Cloud services 110 refers to anything which is part of a service that is hosted remotely and accessible from anywhere via the Internet. Cloud services 110 acts as a central resource for communicating with devices 130 and web devices 150.

Cloud services 110 can provide centralized messaging, computing, data storage, analytics, user management, device 130 management, gateway 120 management, account management, location 140 142 management, control messaging, asynchronous state messaging and displayed information 151. Cloud services 110 can act as a resource that sends and receives data from multiple gateways 120 and multiple devices 130 and consolidates all data to provide a singular list of devices 130 based on location 140, or other grouping, regardless of how the devices 130 are connected and to which gateway 120.

Could services 110 may include software, firmware and hardware, of varying type, at various locations, and provide services to a user seamlessly.

Gateway 120 is a communication bridge that connects device 130 to cloud services 110 via link 164 to Internet or other router 121. In an example, gateway 120 consists of a messaging translator that can receive communication in a first protocol via any device messaging protocol (i.e. Zigbee, Z-wave, Jennet-ip, Enocean, Wi-Fi, powerline communication, Bacnet, Lonworks, Modbus, etc.) and translate to a second protocol, such as a common cloud messaging protocol. Gateway 120 provides a path from any device messaging protocol to cloud services 110. Gateway 120 also provides translation of the second protocol from cloud services 110 to the first protocol to control devices 130. Gateway 120 may include hardware, software, and/or firmware to accomplish some or all of this functionality.

Router 121 can include any router that takes network traffic (i.e. TCP/IP or UDP or other protocol) from a private network and provides access to the public Internet or other network. Router 121 connects gateway 120 to cloud services 110 via links 161.

Device 130 is any electronic device which has a way to communicate via any communication medium (i.e. wireless radio, power-line communication, etc . . . ) and device messaging protocol.

Examples of device 130 may include, but not limited to: light bulbs, lighting drivers, wireless adapters, photo sensors, motion sensors, water/moisture sensors, power usage sensors, position sensors, magnetic sensors, switches, temperature sensors, fluid level sensors, thermostats, network sensors, power outlets, circuit breakers, utility meters, display devices, appliances (washer, dryer, refrigerator, dishwasher, audio/visual equipment, toaster, microwave, oven, stove, coffee maker, etc . . . ), cameras, computers, mobile devices, GPS, locking devices, proximity sensors, security card/badge readers, intrusion sensors, battery sensor, etc.

Device 130 communicates to cloud services 110 via link 164 through gateway 120. Device 130 may be sent messages from cloud services 110 to control the device 130 and also may send messages to cloud services 110 for the purpose of communicating state, status, and other information, etc.

Location(s) 140 142 can include any physical, logical, or other site that one or more gateway 120 and device 130 components physically reside or are able to communicate. Examples include, but are not limited to: commercial buildings, residential homes, industrial buildings, hospitals, hotels, motels, multiple dwelling units, agricultural facilities, etc.

Web device 150 may include any web-connected device that can send and receive messages and display information. Web device 150 communicates to cloud services 110 via link 161. Examples may include: smartphones, tablet computers, laptop computers, desktop computers, server computers, etc. Web device 150 consists of a user interface 152 to visualize displayed information 151 and provide control of displayed information 151 via touch or human interface device (i.e. track pad or mouse).

User interface 152 may also receive user inputs from a user to be sent to cloud serves 110. The user inputs could include grouping information, login information, etc.

Displayed information 151 is received from cloud services 110 through web device 150. No displayed information 151 may be stored on web device 150. It may be just visualized information received from cloud services 110. In this way, displayed information 151 is decoupled from any web device 150 and allows user to see any information provided by cloud services 110 without the need to be physically connected. Furthermore, the user could login from any device or location to see and control the devices 130 and gateways 120.

Displayed information 151 can consist of device 130 status, state, location, groups, other information, etc. Displayed information 151 connects to cloud services 110, which provides a list of devices 130 based on location 140 and has no dependencies on which gateway 120 the device 130 is connected to cloud services 110 through.

Link 161 uses various communication media, such as air, space, metal, optical fiber, or some other signal propagation path, including combinations thereof. Link 161 could use various communication protocols, such as Internet Protocol (IP), Ethernet, Wireless Fidelity (Wi-Fi), Time Division Multiplexing (TDM), Asynchronous Transfer Mode (ATM), Code Division Multiple Access (CDMA), Evolution-Data Optimized (EV-DO), single-carrier radio transmission technology, Frame relay, optical, synchronous optical networking (SONET), or some other communication format, including combinations, improvements, or variations thereof. Link 161 could be a direct link or may include intermediate networks, systems, or devices, and can include wired and/or wireless systems.

Link 164 is the communication that stems from device 130 and may connect to gateway 120 or directly to cloud services 110. Link 164 uses various communication media, such as air, space, metal, optical fiber or some other signal propagation path, including combinations thereof Link 164 could use various communications protocols, such as Internet Protocol (IP), Ethernet, Wireless Fidelity (Wi-Fi_33), Bluetooth, Zigbee, Z-Wave, Enocean, Jennet-IP, NFC, X-bee, 802.15.4, 6LowPAN, TCP/IP, Insteon, ANT, DASH7, NeuRFon, Senceive, WPAN, WirelessHART, Contiki, TinyOS, LONworks, Modbus, BacNet, or some other communication format, including combinations, improvements, or variations thereof. Link 164 could be a direct link or may include intermediate networks, systems, or devices, and can be wired or wireless.

Devices 130 may provide information to gateways 120 generally automatically be broadcasting information. This may be after the device 130 is activated for use. This information can include IP address and setup information. Gateways 120 may be a translation gateway in that the gateways 120 may be capable of receiving information in one protocol from the devices 130 and translating that protocol to a second protocol to be sent to the router 121. Router 121 may then send the translated information to cloud services 110. Similarly, gateway 120 may translate instructions from cloud services 110 to a protocol usable to control devices 130.

Using cloud services 110, a user using web device 150 may receive information about devices 130 and gateways 120 via routers 121. Cloud services 110 may present a list of locations, gateways 120 and devices 130for the user to view, select, associate, group, etc. The user may select the devices 130 to be associated with the gateways 120 without know specific gateway 120 or device 130 information.

The user may then setup the location and other data structures in a logical manner by grouping gateways 120 and devices 130. The user may then log in to their account from any device connected to the Internet and control many gateways 120 and devices 130, without knowing the specific device 130 and gateway 120 information. This may be based on the grouping or virtualization the user accomplishes when setting up the system.

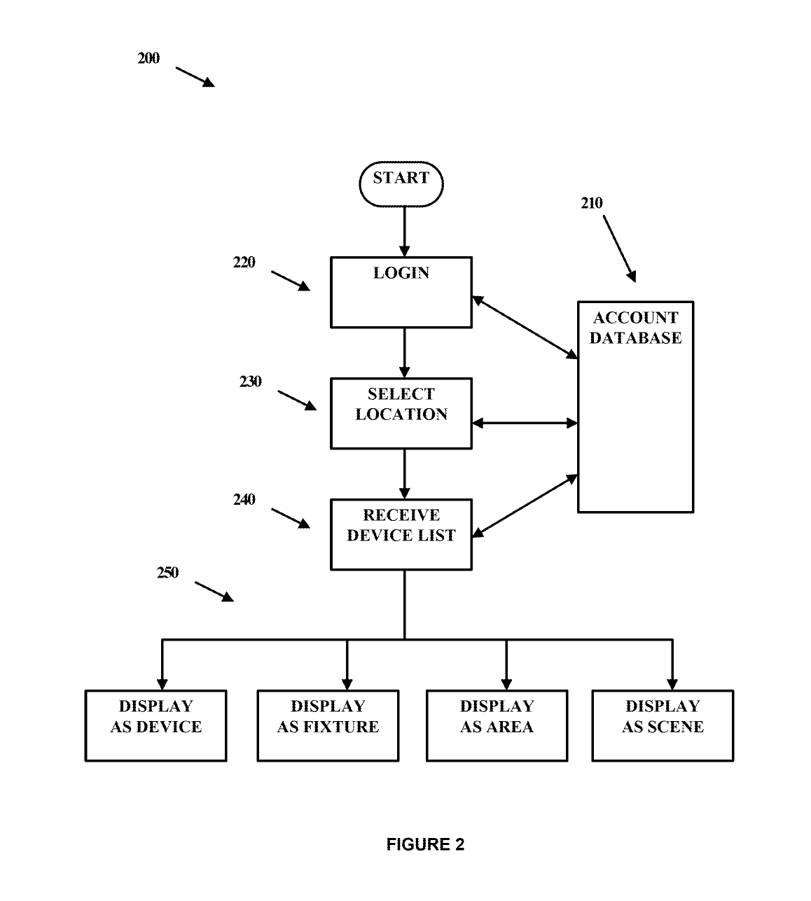

FIG. 2 describes the flow 200 in which an application retrieves and displays information about preconfigured devices 130 from multiple gateways 120 simultaneously in a seamless interface. This is made possible through the use of a consolidated database 210 with multiple collections or data groups.

Each collection or grouping may store separate data that can then be referenced across each collection or grouping. By doing this, data can be compiled from multiple gateways 120 and that information can be displayed as one list or in one user interface to the user via user interface 152. This gives the user a seamless experience and removes the need to access each gateway 120 directly or have the knowledge of which gateway 120 each device 130 is connected to in order to control or receive information from a specific device 130.

In current systems the user may have to know the address or other information of the specific gateways. Furthermore, the user may need to know the specific address and attributes of the devices. The user may then need to enter some or all of this information to connect the devices to the gateways, so that the system may function properly.

Displayed information 151 can be displayed or controlled as individual devices 130 or as groups, such as Fixtures 310 (which is a collection of one or more devices 130), Areas 320 (which is a collection of one or more fixtures), Scenes 330 (which is a collection of one or more fixtures with individually defined set points), or some other grouping format.

A user may login (step 220) using a device 150, which connects to cloud services 110 and database 210. The user may then configure locations 140 and devices 130, with some or all information being stored in database 210. Furthermore the devices may be connected to a network and database 210, such that devices can be controlled via one or more programs, hardware, or software modules within cloud services 110.

Once configured, the user may select location(s) (step 230) to view, control, manipulate, etc. Once a location is selected, the user may be presented with a device list (step 240). The device list may include devices to be controlled 130 or configured for that “location.” The devices 130 may be activated for that location by communicating with a gateway 120 in communication range.

The devices, fixtures, areas, and scenes may be linked to the database 210, such that they may be configured, controlled, changed, manipulated via a web device, using cloud services 110 (step 250).

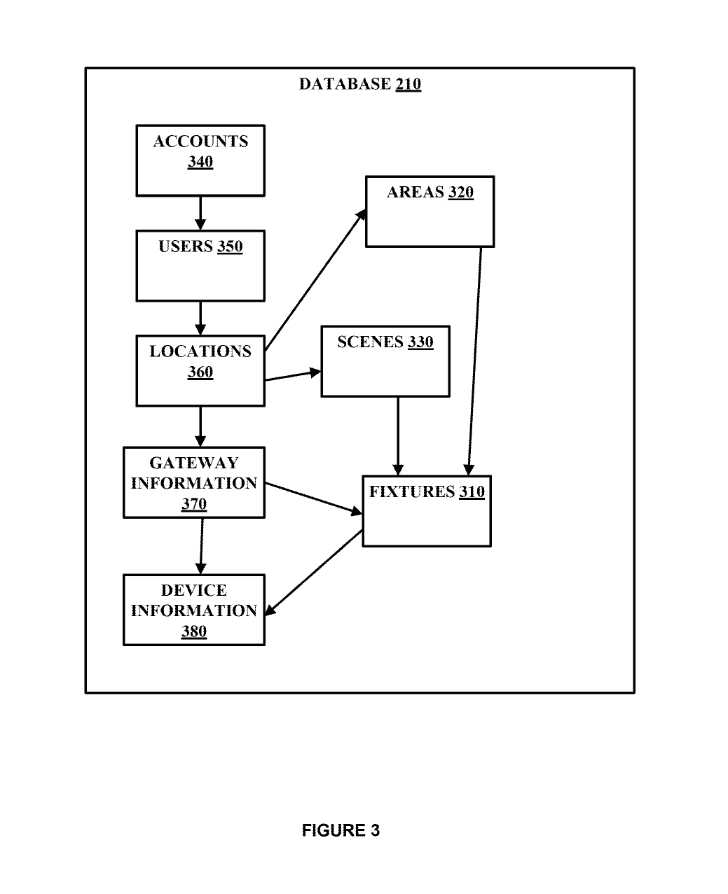

FIG. 3 describes the contents of database 210, according to an example. Database 210 can consist of multiple collections of data. These collections may be defined as Accounts 340, Users 350, Locations 360, Gateway Information 370, Device Information 380, Areas 320, Scenes 330, and Fixtures 310. Other definitions may also be included or created.

Accounts 340 represent the highest level in the data hierarchy, according to an example. All collections or data grouping fall under a specific account, which helps define access to overall data for an account. Users 350 represent individual user accounts that are part of the overall account. There may be more than one user for an account. The ability to control various locations, devices, etc. may be based on the user level of permission, and their login.

Locations 360 represent the physical sites that fall under an account 340. An account 340 can have a limitless amount of locations 360 associated with it.

Gateway Information 370 represents information about the physical hardware gateways 120 that are in a specific location 360 or data structure. Device Information 380 represents information about the devices 130 that are connected to the various gateways 120 and fall under the Gateway Information 370 and collections. Fixtures 310 may represent a collection of one or more devices and fall under gateways.

Areas 320 represent a collection of one or more fixtures 310 and fall under locations 360. By defining in this manner, an area 320 is able to have fixtures 310 from any gateway, without regard to physical connection. Scenes 330 represent a collection of one or more fixtures 310 and can store a specific set point and fall under locations 360. By doing so, a scene 330 is able to have fixtures 310, with specific set points from any gateway, without regard to physical connection.

With this configuration, individual devices 130 may be controlled without regard to device specific information. Furthermore, the specific gateway, or address, or other information does not need to be known to control devices. This system may allow a user to more easily setup and control various devices, groups, etc. and configure the devices in a more user-configured meaningful configuration for the user to better control the devices. This may also allow a user to control devices from any web device, where each web device may not have any specific control application software installed.

Although the example is a device control method, it should be understood that the method could apply to any situation that controls devices. Additionally, it should be understood that the order of events in the methods described herein could be rearranged or accomplished concurrently by various different devices, etc.

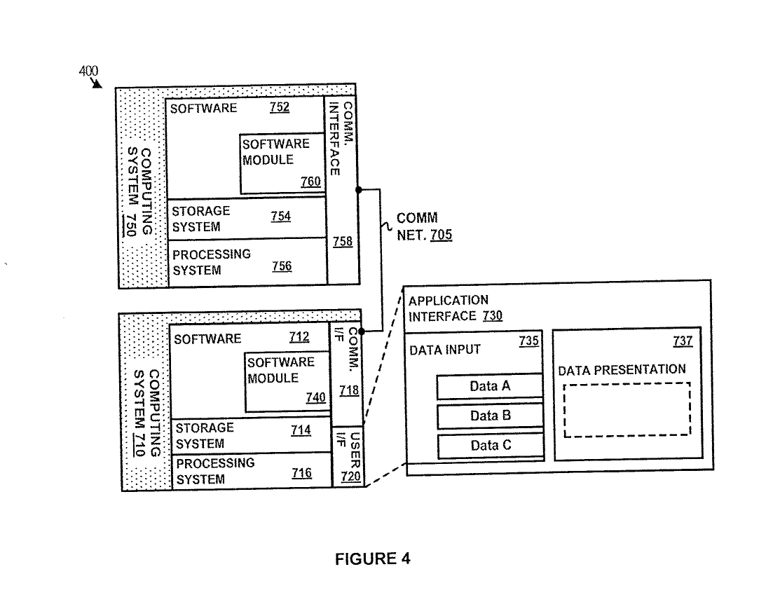

FIG. 4 illustrates a monitoring computing environment 700 according to one example. Computing environment 700 includes computing system 710 and computing system 750. Computing system 710, in the present example, corresponds to web device 150, and computing system 750 corresponds to cloud services 110. Computing system 710 can include any smart phone, tablet computer, laptop computer, or other computing or mobile device capable of reading, and/or recording data about systems, devices, locations, and/or equipment, etc. Computing system 750 can include any server computer, desktop computer, laptop computer, or other device capable of storing and managing the data received from computing system 710 and database 210, as well as hardware and software modules for controlling devices, as described herein.

In FIG. 4, computing system 710 includes processing system 716, storage system 714, software 712, communication interface 718, and user interface 720. Processing system 716 loads and executes software 712 from storage system 714, including software module 740. When executed by computing system 710, software module 740 directs processing system 716 to receive data systems, devices, locations, and/or equipment, etc. Such data could include any of the information described above, including but not limited to the functionality described for FIGS. 1-3.

Although computing system 710 includes one software module in the present example, it should be understood that one or more modules could provide the same operation. Similarly, the computing systems may be distributed using other computing systems and software.

Additionally, computing system 710 includes communication interface 718 that can be further configured to transmit the user inputs and data to computing system 750 using communication network 705. Communication network 705 could include the Internet, cellular network, satellite network, RF communication, blue-tooth type communication, near field, or any other form of communication network capable of facilitating communication between computing systems 710, 750. This includes systems described above for links 161 and 164.

Referring still to FIG. 4, processing system 716 can comprise a microprocessor and other circuitry that retrieves and executes software 712 from storage system 714. Processing system 716 can be implemented within a single processing device but can also be distributed across multiple processing devices or sub-systems that cooperate in executing program instructions. Examples of processing system 716 include general purpose central processing units, application specific processors, and logic devices, as well as any other type of processing device, combinations of processing devices, or variations thereof.

Storage system 714 can comprise any storage media readable by processing system 716, and capable of storing software 712. Storage system 714 can include volatile and nonvolatile, removable and non-removable media implemented in any method or technology for storage of information, such as computer readable instructions, data structures, program modules, or other data. Storage system 714 can be implemented as a single storage device but may also be implemented across multiple storage devices or sub-systems. Storage system 714 can comprise additional elements, such as a controller, capable of communicating with processing system 716.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. It should be understood that in no case is the storage media a propagated signal.

Although one software module is shown, the software may be distributed across many devices, storage media, etc.

User interface 720, of which user interface 152 is an example, can include a mouse, a keyboard, a camera, a touch screen, image capture, a Barcode scanner, a QR scanner, a voice input device, a touch input device for receiving a gesture from a user, a motion input device for detecting non-touch gestures and other motions by a user, and other comparable input devices and associated processing elements capable of receiving user input from a user. These input devices can be used for defining and receiving data about the systems, devices, locations, and/or equipment, etc. Output devices such as a graphical display, speakers, printer, haptic devices, and other types of output devices may also be included in user interface 720. The aforementioned user input and output devices are well known in the art and need not be discussed at length here.

Application interface 730 can include data input 735 and data presentation 737. In one example, data input 735 can be used to collect information regarding a devices, locations, etc. to be controlled.

Further, application interface 730 could include data presentation portion 737, which could be used to present information about systems, devices, locations, and/or equipment, etc. It should be understood that although computing system 710 is shown as one system, the system can comprise one or more systems to achieve the functionality described throughout this disclosure.

In an example, computing system 750 includes processing system 756, storage system 754, software 752, and communication interface 758. Processing system 756 loads and executes software 752 from storage system 754, including software module 760. When executed by computing system 750, software module 760 directs processing system 710 to store and manage the data from computing system 710 and other similar computing systems. The data can include information about devices, locations, etc., as well as one or more software module to control, configure, manipulate devices, etc.

Although computing system 750 is shown as including one software module in the present example, it should be understood that one or more modules could provide the same operation.

Additionally, computing system 750 includes communication interface 758 that can be configured to receive the data from computing system 710 using communication network 705.

Referring still to FIG. 4, processing system 756 can comprise a microprocessor and other circuitry that retrieves and executes software 752 from storage system 754. Processing system 756 can be implemented within a single processing device but can also be distributed across multiple processing devices or sub-systems that cooperate in executing program instructions. Examples of processing system 756 include general purpose central processing units, application specific processors, and logic devices, as well as any other type of processing device, combinations of processing devices, or variations thereof.

Storage system 754 can comprise any storage media readable by processing system 756, and capable of storing software 752 and data from computing system 710. Data from computing system 710 may be stored in a database or any other form of digital file. Storage system 754 can include volatile and nonvolatile, removable and non-removable media implemented in any method or technology for storage of information, such as computer readable instructions, data structures, program modules, or other data. Storage system 754 can be implemented as a single storage device but may also be implemented across multiple storage devices or sub-systems. Storage system 754 can comprise additional elements, such as a controller, capable of communicating with processing system 756.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. It should be understood that in no case is the storage media a propagated signal.

In some examples, computing system 750 could include a user interface The user interface can include a mouse, a keyboard, a voice input device, a touch input device for receiving a gesture from a user, a motion input device for detecting non-touch gestures and other motions by a user, and other comparable input devices and associated processing elements capable of receiving user input from a user.

Output devices such as a graphical display, speakers, printer, haptic devices, and other types of output devices may also be included in the user interface. The aforementioned user input and output devices are well known in the art and need not be discussed at length here.

It should be understood that although computing system 750 is shown as one system, the system can comprise one or more systems to store and manage received data.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for controlling remote devices using a clouds infrastructure, comprising;
receiving device configuration information from devices to be controlled at a translation gateway;
receiving grouping information for the devices to be controlled from a user, at a computing device, wherein the grouping information includes relationships between the devices to be controlled and at least one translation gateway;
receiving login information at the computing device;
presenting the device configuration and grouping information based at least in part on the login information;
receiving user inputs related to the grouping information; and
controlling the devices to be controlled based at least in part on the received user inputs related to the grouping information,
wherein the controlling comprises sending information to the devices to be controlled at least in part via the translation gateway from the computing device.

2. The method of claim 1, wherein the computing device is included in cloud services.

3. The method of claim 1, wherein the translation gateway is configured to translate information to and from one or more of the devices to be controlled in a first protocol to a second protocol usable by the computing device.

4. The method of claim 1, wherein the device information, grouping information, and login information are stored and retrieved by the computing device in a database.

5. The method of claim 1, wherein the user inputs and login information are received at least in part from a web device.

6. The method of claim 1, wherein the grouping information further comprises location information of the devices to be controlled and at least one translation gateway.

7. A non-volatile commuter readable medium, having stored thereon instructions, which if executed by a processor, cause the processor to:
receive device configuration information from devices to be controlled at a translation gateway;
receive grouping information for the devices to be controlled from a user, at a computing device, wherein the grouping information comprises location information, and relationships between the devices to be controlled and at least one translation gateway;
receive login information at the computing device;
present the device configuration and grouping information based at least in part on the login information;
receive user inputs related to the grouping information; and
control the devices to be controlled based at least in part on the received user inputs related to the grouping information,
wherein the control the devices comprises sending information to the devices to be controlled at least in part via the translation gateway.

8. The computer readable medium of claim 7, having further instructions, wherein the computing device is included in cloud services.

9. The computer readable medium of claim 7, having further instructions, wherein the translation gateway is configured to translate information to and from one or more of the devices to be controlled in a first protocol to a second protocol usable by the computing device.

10. The computer readable medium of claim 7, having further instructions, wherein grouping information, and login information are stored and retrieved by the computing device in a database.

11. The computer readable medium of claim 7, having further instructions, wherein the user inputs and login information are received at least in part from a web device.

12. A system for controlling devices, comprising:
a gateway configured to send and receive information from a device to be controlled, the received information comprising device configuration information; and
a computing system capable of sending and receiving information to and from the gateway, the computing system further capable of presenting information related to the device to be controlled and the gateway, and receiving grouping information related to the devices to be controlled and the gateway; wherein the grouping information is used at least in part to control the devices,
wherein the gateway is configured to receive information from the device in one protocol and translate that information to a second protocol to be sent to the computing system,
wherein the gateway is configured to receive information from the computing system in the second protocol and translate that information to the first protocol to be sent to the device.

13. The system of claim 12, wherein the computing device is further capable of receiving login information from a web device, and based at least in part on the login information, present the grouping information, information related to the devices to be controlled, or information related to the gateway.

14. The system of claim 13, wherein the computing device is further capable of receiving control inputs related to the grouping information and controlling the devices to be controlled, based at least in part on the received control inputs.

15. The system of claim 14, wherein the controlling the devices comprises sending information from the computing device at least in part via the gateway.

16. The system of claim 12, wherein the device sends the device configuration information generally automatically to the gateway.

17. The system of claim 12, wherein the grouping information further comprises location information.

18. The system of claim 17, wherein the grouping information further comprises area or fixture information.

19. The system of claim 12, wherein the computing device is included generally in cloud-based services.

20. The system of claim 12, wherein the device to be controlled comprises a light emitting device.
